(19) United States
(12) Patent Application Publication
(10) Pub. No.: US 2013/0186822 A1
(43) Pub. Date: Jul. 25, 2013

(54) LOW ENERGY FORWARD OSMOSIS MEMBRANE WATER PROCESSING SYSTEM

(71) Applicant: HYDRATION SYSTEMS, LLC, Scottsdale, AZ (US)

(72) Inventors: John R. Herron, Corvallis, OR (US); Edward Beaudry, Corvallis, OR (US); Keith Lampi, Corvallis, OR (US); Sherwin Gormly, Carson City, NV (US)

(73) Assignee: HYDRATION SYSTEMS, LLC, Scottsdale, AZ (US)

(21) Appl. No.: 13/746,085

(22) Filed: Jan. 21, 2013

Related U.S. Application Data
(60) Provisional application No. 61/589,132, filed on Jan. 20, 2012.

(51) Int. Cl. C02F 1/44

(52) U.S. Cl. CPC C02F 1/445
USPC 210/601; 210/195.2; 210/170.07; 210/151; 210/641; 210/638

(57) ABSTRACT

Described herein are systems and processes employing a low energy forward osmosis membrane water processing system to simultaneously (1) detoxify reverse osmosis (RO) residual (reject) brines from ground water treatment, and (2) expand available industrial and agricultural ground water supplies.

### CROSS-REFERENCE TO RELATED APPLICATION

This application claims priority to U.S. provisional application Ser. No. 61/589,132 filed on Jan. 20, 2012, the entire disclosure of which is incorporated herein by reference.

### SUMMARY OF THE INVENTION

Described herein are systems and processes employing a low energy forward osmosis membrane water processing system to simultaneously (1) detoxify reverse osmosis (RO) residual (reject) brines from ground water treatment, and (2) expand available industrial and agricultural ground water supplies.

### BACKGROUND

In arid, inland environments, ground water is increasingly being pumped from deeper and saltier aquifers to supply drinking water. This water carries with it many salts at higher quantities than typically found in seawater or surface water. Increased concentration of salts is due to the water having a much longer exposure time with geological formations than more shallow ground water sources in more wet environments.

Even in relatively small quantities, the presence of these trace salts is often unacceptable for drinking water uses. For example, salts found in water pumped from deeper and saltier aquifers may include arsenic, selenium, and other toxic metal salts. Furthermore, overall salt concentrations, measured and reported as total dissolved solids (TDS), can also be too high for general water aesthetics (taste and feel).

Water from deep wells in arid regions is typically treated with a reverse osmosis (RO) membrane treatment system and equipment to make it suitable for drinking RO is highly effective in recovering over 90% of the available water while rejecting all but minute traces of the offending salts. While the treatment is directed primarily at the removal of trace toxic salts, large amounts of conventional salts, such a sodium chloride, and alkalinity, such as calcium carbonate, are also rejected by RO membranes during treatment. This removal further improves the general quality of the water by improving taste and lowering water hardness.

### SUMMARY OF THE INVENTION

A water treatment system for impaired ground water, comprising: a RO system for separating potable water from a reject brine; and a FO/RO system that dilutes the reject brine back to the ground water salt concentrations by osmotically extracting water from wastewater. The diluted brine, being substantially the same as the extracted water, is then suitable for reinjection into the ground or for use in an agricultural or industrial process.

### BRIEF DESCRIPTION OF THE DRAWING

FIG. 1 is a schematic illustration of the process and system according to a preferred embodiment of the invention.

### DETAILED DESCRIPTION OF THE INVENTION

### Overview

This invention relates to the identification and solving of a significant problem with prior art treatment of water, particularly water obtained from aquifers in arid geographic regions. Disclosed herein are systems and processes which avoid the negative consequences of prior art systems, wherein high strength brine with toxic properties is rejected from the RO system as a large volume waste product, referred to as RO treatment residuals. This residual material is a serious environmental liability, particularly in arid areas where much of the RO ground water recovery is conducted with no available natural dilution capacity. Reinjection of the brine into the deep aquifer degrades the aquifer water quality and is in many cases prohibited.

This document discloses a system and method using the use of rejected brine from RO ground water treatment to drive the subsequent membrane treatment of available wastewater. This simultaneously treats the wastewater to reuse or re-injection standard and absorbs the ground water salts in the wastewater solids.

The driving force for membrane water treatment is the osmotic potential in the reject brine. This process is called forward osmosis (FO), to distinguish it from other pressure (pump) driven membrane processes. FO utilizes the passive drawing force of the salts to drive the water across the membrane from the wastewater into the product water side. FO is also extremely low fouling, because with low hydrostatic pressure and relatively high surface shear at the membrane, the conditions that would force particles into the membrane pores in RO or pump pressure driven systems are not present in FO. Thus, the particles are not drawn into and embedded in the FO membrane pores. As a result, FO processing has extremely low fouling potential in comparison to other membrane processes like RO. The FO concentration can be performed in the aerobic digestion tanks in the manner of an osmotic membrane bioreactor.

Implementations of the current disclosure improve upon the system architecture by which a FO/RO process is applied in a comprehensive water management architecture for an arid region and/or saline ground water affected municipal systems. The use of the FO in various implementations described herein not only treats wastewater (FO flowed by RO) but also essentially doubles uses of the water in a municipal system. This effectively doubles the water available to a community based on the total water pumped from ground water. Implementations discussed herein also provide an environmentally responsible management of these salts in a sustainable manner. In another embodiment of the system and method of the invention, reject brine water from RO treatment of ground water is treated using an FO process with available wastewater, in combination with a secondary RO treatment, to produce diluted brine; the diluted brine has its concentration adjusted to be chemically similar to the original ground water, and is then able to be reinjected into the aquifer with no net impact on ground water volume or salinity. Filtered wastewater in this embodiment is not used as the source for drinking water.

### System and Processes

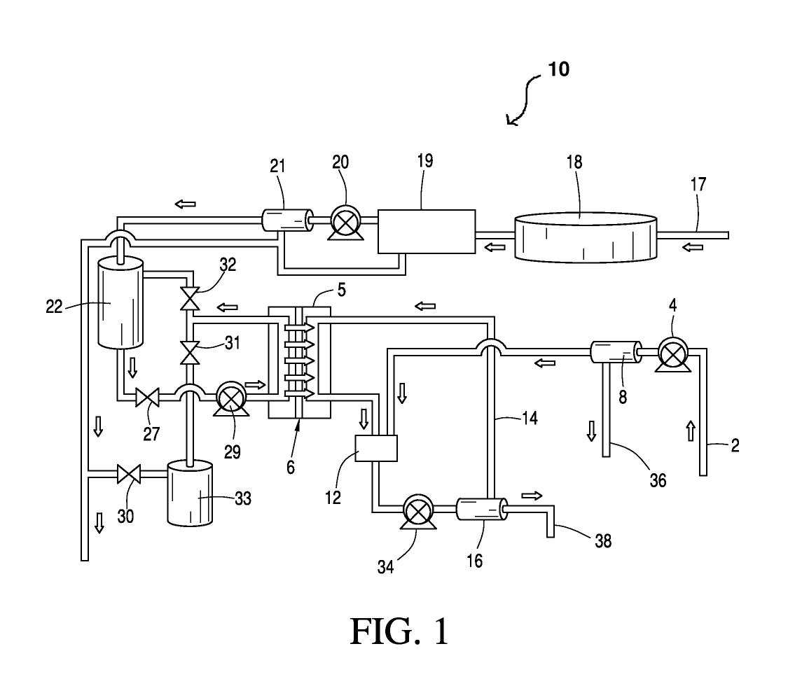

An exemplary embodiment of the system 10, comprising its combined process architecture for brine-driven forward osmosis wastewater treatment and ground water RO brine detoxification and subsequent beneficial reuse is illustrated in FIG. 1. Ground water is pumped and treated using RO, typically with existing infrastructure. In other implementations, the ground water may be treated utilizing a new RO system specifically implemented for this system. The reject brine from the RO system is then sent to the wastewater treatment facility, where it is used to recover reusable or reinjectable water by a FO process.

FIG. 1 illustrates a first conduit 2 and first pump 4 for conveying water from a ground water well (not shown) into the primary RO unit 8. The RO unit has a first outlet for the drinking water it produces and a second outlet for the reject brine it produces. Drinking water produced by RO unit 8 leaves the system 10 via conduit 36. The reject brine is conveyed to a brine loop reserve tank 12, where it combines with dilute brine from a FO/RO loop 14. The combined brine is conveyed to the secondary RO unit 16, which produces high-grade recovered water at or below ground water salinity. The reject water from secondary RO unit 16 is conveyed to FO membrane element 5, also referred to as the FO treatment loop tank, where the reject water performs as the draw solution.

The RO reject brine is circulated on one side of the FO membrane, shown as the right side in FIG. 1. The RO reject side loop, also known as the brine loop 14, may initially be supplied with the drinking water RO reject brine from RO unit 8. In some implementations, however, the brine loop may be continuously supplied by a secondary RO unit 16. RO unit 16 receives fluid from RO element 8 and from water transfer across the membranes in FO element 5. Optionally, a pump 34 may be disposed in front of RO unit 16, to assist in conveying fluid to unit 16.

This secondary RO unit 16 may then utilize the reject brine a plurality of times to drive the overall FO process. Rejection of salts in an RO element similar to the secondary RO unit 16 is a function of pressure and water recovery rate. By manipulating the pressure on the secondary RO unit 16 associated with the FO brine loop, the high-grade water recovery/production rate at the FO element and the rate of salt loss to the product water may be simultaneously controlled. By adjusting the applied pressure and membrane permeability, the water quality in the permeate water in RO element 16 can be adjusted. High-grade recovered water that is at or below ground water salinity leaves the system 10 via conduit 38. This high-grade recovered water may optionally be re-introduced to the aquifer from which the ground water was originally obtained, or may be introduced in another location.

Wastewater from secondary settling, clarification, or secondary effluent from existing wastewater treatment facility is collected and sent to the FO treatment loop tank. FIG. 1 illustrates an embodiment of the invention showing the inclusion in the system 10 of components for producing secondary effluent from a wastewater treatment facility. Wastewater enters the system 10 via a conduit 17, and enters a secondary wastewater digester/aerator 18. After treatment in element 18, the wastewater travels to a gravity separation unit, and may thereafter optionally be subject to ultrafiltration in an ultrafiltration unit 21. Optionally, a pump 20 may be used to assist in conveying the wastewater stream to unit 21. Sludge resulting from gravity separation and ultrafiltration in elements 19 and 21, respectively are conveyed to a sludge dewatering facility, not shown in FIG. 1. The secondary effluent water resulting from the gravity separation and ultrafiltration are conveyed to brine loop reserve tank 22. The clarified wastewater leaves the bottom of tank 22 and is conveyed to the FO membrane element 5, optionally via pump 29. Valves 27, 30, 31 and 32 are used to control the flow of fluid through the various conduits. At the FO treatment loop tank, the secondary effluent is circulated on one side of the tank, shown as the left side in FIG. 1. Circulation of the secondary effluent may continue until the desired recovery percentage across the FO membrane 6 is achieved. The FO reject is relatively concentrated wastewater sludge, comprising up to approximately 2% solids, and is substantially similar to the primary and secondary settling solid delivered to the sludge digester at the wastewater treatment plant. In a similar manner, the FO membranes could be located in the aerobic tank of the treatment plant to provide an osmotic membrane bioreactor system.

In some implementations, the salt may eventually exit and be lost primarily through the FO element and end up in the wastewater solids (sludge). This result may be the most desirable result for the majority of the salts, as the wastewater solids may absorb large quantities of these salts and still be good for beneficial reuse. The salts may be absorbed and form complex, less toxic compounds in these solids that pass the Toxicity Characteristic Leaching Procedure standards for benign waste solids. In other implementations, the second RO system 16 may be designed to “leak” or release salt at a desired rate into the permeate as well to provide water for reinjection into the aquifer. In still other implementations, both results may occur. The balance of the system may be optimized for a given application that is based on brine loop RO membrane selection. For example, municipality water reuse and total dissolved solids (TDS) total load management strategy may require both leaking of some salts and/or the exit of salts to be absorbed by the solids.

In various aspects, the secondary water exiting the FO system and/or the secondary RO system may be utilized as a high grade recovered water that is at or below ground water salinity or for any other secondary use. Examples may included but are not limited to surface irrigations, cooling towers, industrial cooling process, nuclear power plants, recharging, and the like.

In one aspect, the brine loop or secondary RO pump may act as a speed control for the rate at which the FO element will harvest wastewater and consume RO reject brine. The per product water volume and salt loss rate may, in some implementations, be dictated by the RO membrane selected and pressure used to drive the brine loop RO element. Once selected, the RO element may remain the same in most implementations. In most implementations, salt migration rates may all be relatively constant, based on good design and consistent product water targets. These may, however, be moved slightly or significantly by manipulating the brine loop RO pump pressure alone in various implementations. In various implementations, the system may comprise either a batch process or a continuous process.

The salt back flux across the FO membrane may comprise lower concentrations complexed with clay, organics, and/or other compounds such that the salt is no longer a free toxin. These resulting complex materials may then be utilized as cap materials in landfills because the toxins will not leach out of the complex materials. The complex materials material may be further utilized in a variety of applications.

Specifications, Materials, Manufacture, Assembly

In a preferred embodiment, the system for treating reverse osmosis reject brines, comprises at least (a) a primary RO unit for treating saline-containing water; (b) a secondary RO unit for treating reject water produced by the primary RO unit; (c) a forward osmosis (FO) membrane element unit; (d) a loop for conveying reject water produced by the secondary RO unit to a first side of a forward osmosis membrane in the forward osmosis membrane unit; and (e) a loop for conveying treated wastewater to a second side of the FO membrane.

In a preferred embodiment, the process of the invention comprises the following steps:

(a) subjecting saline-containing ground water to a first reverse osmosis treatment to produce a first reject brine and drinking water;

(b) subjecting the reject brine to a second reverse osmosis treatment to produce a second reject brine and water that is at or below the ground water's salinity; and

(c) using the first and second reject brines as draw solution in a forward osmosis membrane element unit to extract water from wastewater.

In another preferred embodiment, step (c) further comprises conveying the first and second reject brines to a first side of a forward osmosis membrane in the forward osmosis membrane unit, and conveying the wastewater to a second side of the forward osmosis membrane in the forward osmosis membrane unit. In yet another preferred embodiment, the process involves treating the wastewater prior to conveying it to the forward osmosis membrane unit by at least one of the following processes: digestion, aeration, filtration, and gravity separation.

Essentially, the water treatment system of the invention treats groundwater containing various salts, and comprises an RO system for separating potable water from a reject brine; and an FO/RO system for diluting the reject brine to ground water salt concentrations by osmotically extracting water from wastewater.

In the system, the forward osmosis (FO) membrane element unit is driven by the reject water produced by the primary RO unit and/or the secondary RO unit.

In a still more preferred embodiment, the system further comprises a loop for conveying, to second side of the forward osmosis membrane, wastewater or secondary effluent from a wastewater treatment facility. The system may further comprise one or more of the following components: a wastewater digester/aerator 18, a gravity separator 19 and an ultrafiltration unit 21, which treat the wastewater entering the system, typically after the wastewater has received an initial (primary) treatment. Another embodiment called the osmotic membrane bioreactor embodiment, removes the FO wastewater recirculation loop and places the FO element 5 directly in tank 18. Circulation of wastewater through element 5 in then provided by the flow caused by tank aeration.

It will be understood that implementations are not limited to the specific components disclosed herein, as virtually any components consistent with the intended operation of a FO/RO combination treatment system may be utilized. Accordingly, for example, although particular components and so forth, are disclosed, such components may comprise any shape, size, style, type, model version, class, grade, measurement, concentration, material, weight, quantity, and/or the like consistent with the intended operation of a FO/RO combination treatment system. Implementations are not limited to uses of any specific components, provided that the components selected are consistent with the intended operation of a FO/RO treatment system.

Accordingly, the components defining any FO/RO treatment system may be formed of any of many different types of materials or combinations thereof that can be readily formed into shaped objects provided that the components selected are consistent with the intended operation of a FO/RO combination treatment system. As a restatement of or in addition to what has been already been described and disclosed above, the system may comprise at least one RO system and at least one FO system. The first RO system may be associated with a saline ground water well or any other water source and may provide drinking water after the saline ground water has been processed by the first RO system. The first RO system may comprise any membrane suitable for separating at least a portion of salts or brines from saline ground water.

At least one FO system may be associated with a wastewater system on a first side of the FO and RO reject brine on a second side. In various implementations, the wastewater system may comprise a wastewater input line. The wastewater input line may be from a primary treatment, a secondary treatment, or any other wastewater treatment system. Various implementations of the wastewater system may further comprise any combination elements or machinery for secondary wastewater digesters/aeration, gravity separation, and ultrafiltration (UF). The wastewater system may further comprise a second effluent concentration and reject loop. The wastewater system may pump varying levels of treated wastewater to the first side of the FO system.

The FO/RO combination treatment system may further comprise a brine loop reserve tank and a speed control system. The brine loop reserve tank and the speed control system may be associated with a second RO system that at least partially separates brine, salts, or other toxins from the water before sending high grade recovered water at or below ground water salinity out of the FO/RO combination treatment system. The reject brine from the second RO system may be sent again to the FO system for additional use.

### Use

In an implementation, the FO/RO combination treatment system may be utilized in an arid environment that typically pumps saltier water from deep wells. The FO/RO combination system, however, may be utilized in any type of environment to treat water, dispose of reject brine, and/or prepare industrial use water. In places where the description above refers to particular implementations, it should be readily apparent that a number of modifications may be made without departing from the spirit thereof and that these implementations may be alternatively applied. This document is intended to cover such modifications as would fall within the true spirit and scope of the disclosure set forth in this document. The presently disclosed implementations are, therefore, to be considered in all respects as illustrative and not restrictive.

1. A system for treating reverse osmosis reject brines, comprising:
(a) a primary RO unit for treating saline-containing water;
(b) a secondary RO unit for treating reject brine produced by the primary RO unit;
(c) a forward osmosis (FO) membrane element unit; and
(d) a loop for conveying reject brine produced by the secondary RO unit to a first side of a forward osmosis membrane in the forward osmosis membrane unit.

2. The system of claim 1, wherein the forward osmosis (FO) membrane element unit is driven by the reject brine produced by the primary RO unit and/or the secondary RO unit.

3. The system of claim 2, further comprising:
(e) a means for conveying, to second side of the forward osmosis membrane, wastewater or secondary effluent from a wastewater treatment facility.

4. The system of claim 3, further comprising one or more of the following: a wastewater digester/aerator, a gravity separator and an ultrafiltration unit.

5. The system of claim 3, where the means for conveying is a loop.

6. The system of claim 3, further comprising a wastewater digester/aerator and the forward osmosis (FO) membrane element unit is in the wastewater digester/aerator.

7. A water treatment system for salt-containing groundwater, comprising:
(a) an RO unit for separating potable water from a reject brine; and
(b) an FO/RO system for diluting the reject brine to ground water salt concentrations by osmotically extracting water from wastewater.

8. A process for treating salt-containing ground water comprising the steps of:
(a) subjecting said ground water to a first reverse osmosis treatment to produce a first reject brine and drinking water;
(b) subjecting the reject brine to a second reverse osmosis treatment to produce a second reject brine and water that is at or below the ground water's salinity; and
(c) using the first and second reject brines as draw solution in a forward osmosis membrane element unit to extract water from wastewater.

9. The process of claim 8, wherein step (c) further comprises conveying the first and second reject brines to a first side of a forward osmosis membrane in the forward osmosis membrane unit, and conveying the wastewater to a second side of the forward osmosis membrane in the forward osmosis membrane unit.

10. The process of claim 8, further comprising the steps of treating the wastewater prior to conveying it to the forward osmosis membrane unit by at least one of the following: digestion, aeration, filtration, and gravity separation.
